(19) United States
(12) Patent Application Publication
(10) Pub. No.: US 2026/0292182 A1
(43) Pub. Date: Sep. 24, 2026

(54) PROTECTION MASK CODING FOR REPRODUCIBLE LEARNING-BASED COMPRESSION

(71) Applicant: InterDigital VC Holdings, Inc., Wilmington, DE (US)

(72) Inventors: Jiahao Pang, Plainsboro, NJ (US); Muhammad Asad Lodhi, Highland Park, NJ (US); Junghyun Ahn, New York, NY (US); Dong Tian, Boxborough, MA (US)

(21) Appl. No.: 19/088,367

(22) Filed: Mar. 24, 2025

(51) Int. Cl. H04N 19/132; H04N 19/169; H04N 19/65; H04N 19/96

(52) U.S. Cl. CPC H04N 19/132; H04N 19/1883; H04N 19/65; H04N 19/96

(57) ABSTRACT

Some embodiments of a method may include: obtaining a threshold index and an octree level index; determining a risky probability based on the threshold index and the octree level index; and decoding, with an arithmetic decoder, the binary protection mask based on the risky probability. Some other embodiments of a method may include: obtaining a threshold index and an octree level index; determining a risky probability based on the threshold index and the octree level index; and encoding, with an arithmetic encoder, the binary protection mask based on the risky probability

### INCORPORATION BY REFERENCE

The present application incorporates by reference in their entirety the following applications: U.S. Non-Provisional patent application Ser. No. ______, entitled “SUBSTREAM MULTIPLEXING APPROACH FOR LEARNING-BASED POINT CLOUD COMPRESSION” and filed Mar. 24, 2025 (“'______ application”); U.S. Non-Provisional patent application Ser. No. 18/830,379, entitled “VOXEL-WISE CODING CONTROL METHOD FOR LOSSLESS POINT CLOUD COMPRESSION” and filed Sep. 10, 2024 (“'379 application”); and U.S. Non-Provisional patent application Ser. No. 18/637,370, entitled “REPRODUCIBLE LEARNING-BASED POINT CLOUD CODING” and filed Apr. 16, 2024 (“'370 application”).

### BACKGROUND

The present application is related to point clouds.

### SUMMARY

A first example method in accordance with some embodiments may include: obtaining a threshold index and an octree level index; determining a risky probability based on the threshold index and the octree level index; and decoding, with an arithmetic decoder, the binary protection mask based on the risky probability.

Some embodiments of the first example method may further include determining that the octree level index is equal to the threshold index, wherein determining the risky probability includes determining the risky probability statistically.

Some embodiments of the first example method may further include determining that the octree level index is less than the threshold index, wherein determining the risky probability includes determining the risky probability statistically.

For some embodiments of the first example method, determining the risky probability statistically includes determining the risky probability based on a maximum error and a quantization step size.

Some embodiments of the first example method may further include determining that the octree level index is greater than the threshold index, wherein determining the risky probability includes decoding the risky probability.

Some embodiments of the first example method may further include: obtaining a bitstream; decoding the bitstream; and parsing the risky probability from the decoded bitstream.

Some embodiments of the first example method may further include repeating a decoding loop for a second octree-level, wherein the decoding loop includes: obtaining a second threshold index and a second octree level index; determining a second risky probability based on the second threshold index and the second octree level index; and decoding, with the arithmetic decoder, a second binary protection mask based on the second risky probability.

For some embodiments of the first example method, the threshold index is a single digit constant.

A first example apparatus in accordance with some embodiments may include: a processor; and a memory storing instructions operative, when executed by the processor, to cause the apparatus to: obtain a threshold index and an octree level index; determine a risky probability based on the threshold index and the octree level index; and decode, with an arithmetic decoder, the binary protection mask based on the risky probability.

A second example method in accordance with some embodiments may include: obtaining a threshold index and an octree level index; determining a risky probability based on the threshold index and the octree level index; and encoding, with an arithmetic encoder, the binary protection mask based on the risky probability.

Some embodiments of the second example method may further include determining that the octree level index is equal to the threshold index, wherein determining the risky probability includes determining the risky probability statistically.

Some embodiments of the second example method may further include determining that the octree level index is less than the threshold index, wherein determining the risky probability includes determining the risky probability statistically.

For some embodiments of the second example method, determining the risky probability statistically includes determining the risky probability based on a maximum error and a quantization step size.

Some embodiments of the second example method may further include determining that the octree level index is greater than the threshold index, wherein determining the risky probability includes determining the risky probability empirically.

For some embodiments of the second example method, determining the risky probability empirically includes determining the risky probability based on total number of voxels coded and number of risky voxels within the total number of voxels coded.

For some embodiments of the second example method, determining the risky probability empirically is determined specifically for the octree level corresponding to the octree level index.

Some embodiments of the second example method may further include encoding the risky probability into a bitstream.

Some embodiments of the second example method may further include repeating an encoding loop for a second octree-level, wherein the encoding loop includes: obtaining a second threshold index and a second octree level index; determining a second risky probability based on the second threshold index and the second octree level index; and encoding, with the arithmetic encoder, a second binary protection mask based on the second risky probability.

For some embodiments of the second example method, obtaining the threshold index includes determining the threshold index.

For some embodiments of the second example method, determining the threshold index includes setting the threshold index based on density of the binary protection mask.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a flowchart illustrating a first example reproducible encoder process according to some embodiments.

FIG. 3 is a flowchart illustrating a first example reproducible decoder process according to some embodiments.

FIG. 4 is a schematic illustration showing a first example matching of raw values with quantized values according to some embodiments.

FIG. 5 is a flowchart illustrating a second example reproducible encoder process according to some embodiments.

FIG. 6 is a flowchart illustrating a second example reproducible decoder process according to some embodiments.

FIG. 7 is a schematic illustration showing a second example matching of raw values with quantized values according to some embodiments.

FIG. 8 is a flowchart illustrating an example encoder process according to some embodiments.

FIG. 9 is a flowchart illustrating an example decoder process according to some embodiments.

FIG. 10 is a flowchart illustrating an example decoding process according to some embodiments.

FIG. 11 is a flowchart illustrating an example encoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

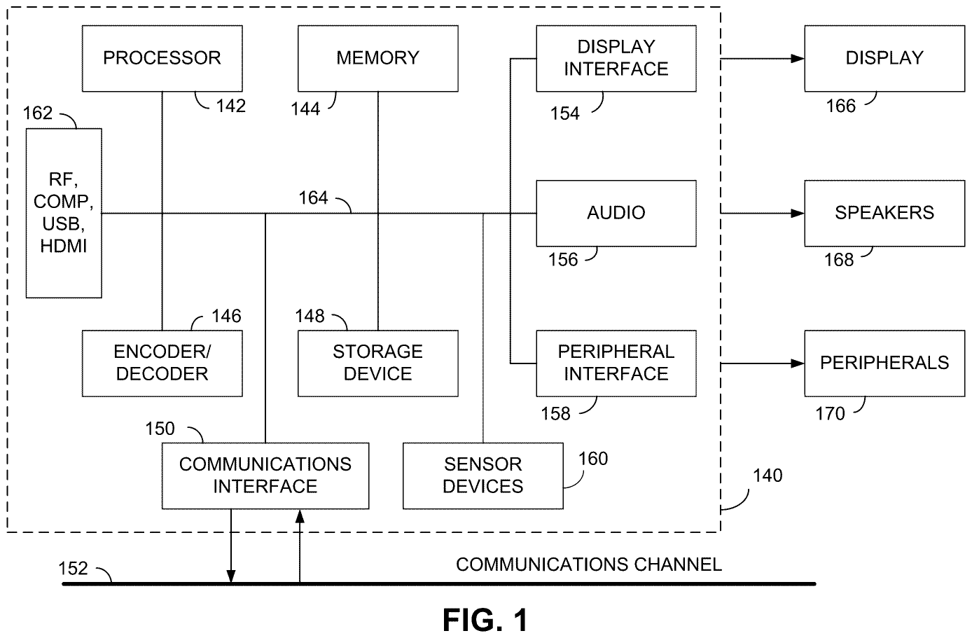

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any eXtended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation, and understanding of input signals, such as point clouds.

Point cloud data is a universal data format used across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020, and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when storage and transmission of the data are used in related scenarios.

Furthermore, point clouds may represent a sequential scan of the same scene, which contains multiple moving objects. They are called dynamic point clouds, while static point clouds may be captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the application. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer, while in standard TV, the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings, in which objects, like statues or buildings, are scanned in 3D to share the spatial configuration of the object without sending or visiting the statues or buildings. Also, point clouds offer a way to ensure preservation of knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data includes discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry information and attribute information, the compression of point clouds may be classified into two categories: geometry coding and attribute coding.

Examples of existing learning-based point cloud geometry compression techniques include deep octree coding and end-to-end feature-based geometry coding. With deep octree coding, neural network-based models are utilized to estimate the occupancy probabilities. Such estimated probabilities may be used to help the arithmetic coder to encode or decode a binary flag indicating whether a child octree voxel is occupied or empty.

Inference reproducibility is a well-known problem. Neural network models may produce results with minor differences when they run on different hardware or software platforms or when they run multiple times. The '370 application introduces a method to achieve reproducibility for learning-based compression, which is applicable to both point clouds and image compression. The '370 application achieves reproducibility at the cost of additional overhead. The present application reduces the overhead when the '370 application is applied to multiscale coding.

The '370 application proposed an approach to achieve reproducible coding for learning-based compression, at the cost of coding and additional protection mask. The '370 application discusses a method to code protection masks for multi-scale point cloud coding. For the protection masks associated with the first few octree levels, they are arithmetically coded with statistical risky probabilities; for the protection masks associated with the remaining octree levels, they are arithmetically coded with empirical risky probabilities.

The '370 application serves as the basis of the present application. The '370 application achieves inference reproducibility in learning-based point cloud compression. The same method may be applied to learning-based image/video compression as well.

### Reproducibility Compatibility

An AI-based module [symbol] is assumed to be deployed to compute a scalar variable per sample. The sample is a point in point cloud compression or a pixel in image/video compression. The scalar variable may be the probability of a child octree voxel being occupied in deep octree coding. While a hyperprior model, the variable may be the Gaussian distribution parameters, e.g., mean and variance numbers.

Let vₓ be the variable in which x is the sample. Typically, vₓ is a floating-point number computed by an AI-based model. Though some AI-based blocks may use integers as neural network weights, the output may still not be reproducible. Without losing generality, the variable vₓ may be assumed to be a floating-point number, which suffers a reproducibility problem across different platforms.

For decoding reproducibility, a reproducibility compatible AI-based decoding method shall be able to decode a bitstream on different platforms with the quality of decoded point cloud (or image/video) being either exactly the same or within a specific mismatch error when the method is run on different platforms.

For encoding/decoding reproducibility, a reproducibility compatible AI-based decoding method shall be capable of decoding a bitstream on a platform and reconstructing exactly the same point cloud (or image/video) or within a specific mismatch error when compared to the point cloud reconstructed (during encoding) on a different platform.

Before presenting a method to achieve reproducibility for both paradigms, a maximum error in the variable vₓ is assumed to exist among different targeted platforms. Given an AI-based model [symbol] , a maximum error max_err may be evaluated between the targeted platforms e.g., between different hardware platforms, such as GPUs. For each particular AI-based model [symbol] , a table of maximum errors between any two GPU models is provided for reference, which is referenced as table GPU_MAX_ER [symbol] in this application.

A maximum tolerable error E is signaled to the decoder using a high-level syntax element in a sequence parameter set, picture parameter set, or supplemental enhancement information message (SEI). This maximum tolerable error E is accompanied by a second syntax element ref_gpu, which indicates the GPU model on which the bitstream was encoded. In table GPU_MAX_ER [symbol] , the decoder may access the maximum error max_err between the actual GPU model (to run the decoding) and the GPU model used in encoding. If the maximum error max_err is found to be small or equal to E, the decoding may be guaranteed to be properly performed.

A quantization may be applied on the variable vₓ. However, quantization alone will not guarantee achieving the reproducibility, no matter how small the maximum error max_err is. In fact, when the variable vₓ falls within a vicinity of quantization boundaries, the quantized value may become different across different GPUs. The quantization function on the variable vₓ may be a function related to the quantization step QS as shown in Eq. 1:

$$Q ( {v}_{x} ) = int ( \frac{{v}_{x}}{Q S} + 0.5 ) \qquad ( 1 )$$

where the int(⋅) may be a flooring function to the closest integer number not larger than a given number. The '370 application assumes a uniform quantization function, while advanced quantization functions may be applied in a similar way.

More advanced quantization methods may have additional parameters, such as offset and scaling parameters. When offset is introduced, the quantization function becomes Eq. 2:

$$Q ( {v}_{x} ) = int ( \frac{{v}_{x} + OFFSET}{Q S} + 0.5 ) \qquad ( 2 )$$

When scaling is further introduced, the quantization function becomes Eq. 3:

$$Q ( {v}_{x} ) = int ( \frac{SCALING \cdot {v}_{x} + OFFSET}{Q S} + 0.5 ) \qquad ( 3 )$$

### Basic Reproducible Coding

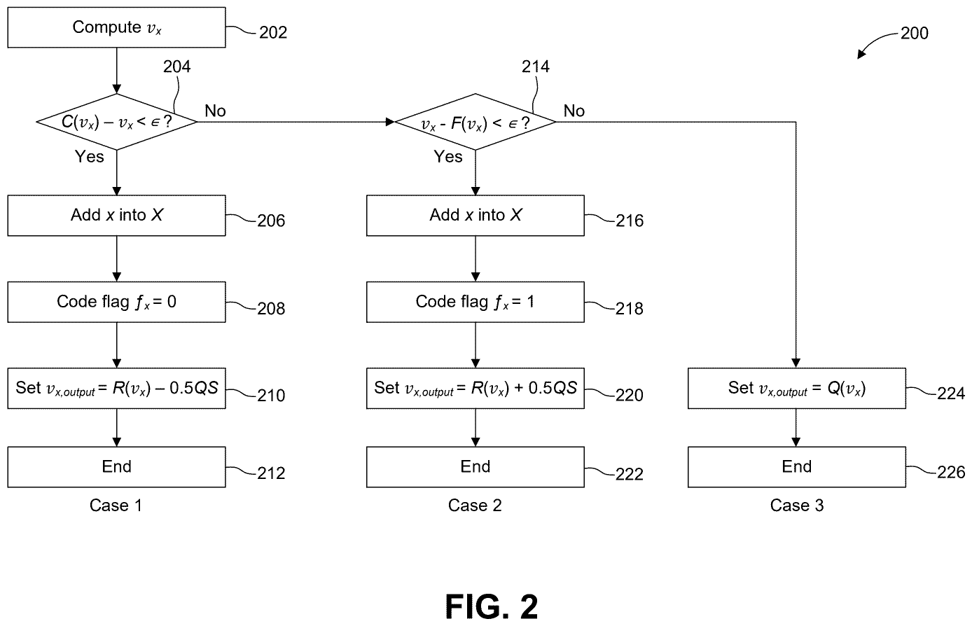

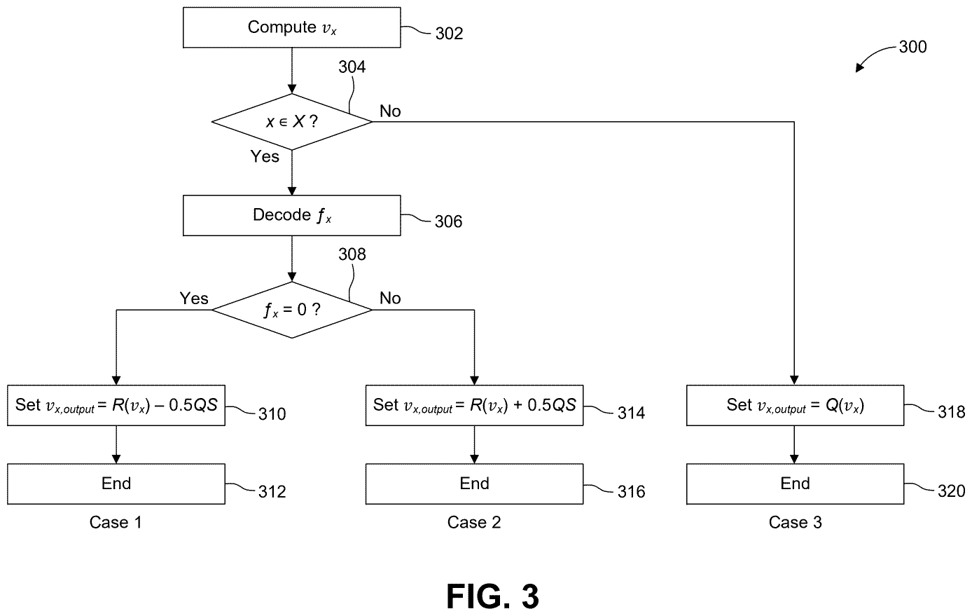

FIG. 2 is a flowchart illustrating a first example reproducible encoder process according to some embodiments. The reproducible coding method of the '370 application is shown in the flowcharts for the encoder (FIG. 2) and the decoder (FIG. 3).

As shown in FIG. 2, for a current point x, the encoding method 200 starts with computing 202 the variable vₓ by running the AI model [symbol] on the encoder's GPU. Two conditions are checked 204, 214 against the ceiling and floor values respectively. For illustration, the ceiling function C(vₓ) is defined as the function that computes the upper quantization boundary associated to vₓ. In contrast, the floor function F(vₓ) computes the lower quantization boundary.

If vₓ is close to its ceiling within a threshold E, which is also the maximum tolerable error for decoding, the current point x (or pixel in image/video) is added 206 into a risky set X that needs extra care to ensure reproducibility. The risky set X may be coded into the bitstream. In some embodiments, the risky set X is encoded directly because the risky set X is a list of points. That is, the 3D position of each point in X is coded.

In some embodiments, a flag is associated with all points to indicate whether or not a point belongs to set X. For example, a coded flag set to True means that the corresponding point x belongs to X. Moreover, a flag fₓ=0 is coded 208 into a bitstream to indicate that the quantized value of the variable vₓ should be on the left side of its rounded value. That is, for vₓ, the encoding sets 210 (outputs) a value v_{x,output}=R(vₓ)−0.5QS. The subtraction of 0.5QS results in shifting the value to the left by half of the quantization step. R(vₓ) is a rounding function that rounds vₓ to the closest quantization boundary value. Case 1 of FIG. 2 then exits 212.

If vₓ is close to its flooring F(vₓ) within a threshold E, a similar procedure is performed. The current point x is added 216 into X. The flag fₓ=1 is coded 218 into the bitstream in this case. The output value is set 220 to v_{x,output}=R(vₓ)+0.5QS. The adding of 0.5QS results in shifting the value to the right by half of the quantization step. Case 2 of FIG. 2 then exits 222.

If vₓ is not close to either ceiling or flooring values, the quantization is safe and may be reproduced on the decoder. The output is set 224 to v_{x,output}=Q(vₓ). Case 3 of FIG. 2 then exits 226.

FIG. 3 is a flowchart illustrating a first example reproducible decoder process according to some embodiments. For a current point x, the decoding method 300 starts with computing 302 the variable vₓ by running the AI model [symbol] on the decoder's GPU. The value of vₓ may have a minor difference compared to the value computed at the encoder on a different GPU. The decoder then checks 304 if x belongs to the risky set X. If not, the variable vₓ's value is assumed as in a safe range, and a quantization 318 is done and v_{x,output}=Q(vₓ) is outputted. Case 3 of FIG. 3 then exits 320.

If x belongs to the set X, there are chances for vₓ to be either larger than or smaller than its rounded value R(vₓ) (which is the closest quantization boundary) while vₓ is within a maximum error range. A mismatch in quantization will happen if the encoding and decoding fall on different sides of the rounded value. For some embodiments, the flag fₓ is used to control the mismatch. The flag fₓ is decoded 306. A check 308 is made to determine if fₓ=0.

If fₓ=0 is decoded, the output of vₓ is set 310 to v_{x,output}=R(vₓ)−0.5QS. That is, the encoder tells the decoder that the encoded value falls on the left side of the rounded value. So, the decoder needs to do the same. This is implemented using R(vₓ)−0.5QS rather than Q(vₓ), because Q(vₓ) may go to the right side of the rounded value. Case 1 of FIG. 3 then exits 312.

If fₓ=1 is decoded, the output of vₓ is set 314 to v_{x,output}=R(vₓ)+0.5QS. In this case, the encoder tells the decoder that the encoded value falls on the right side of the rounded value. Case 2 of FIG. 3 then exits 316.

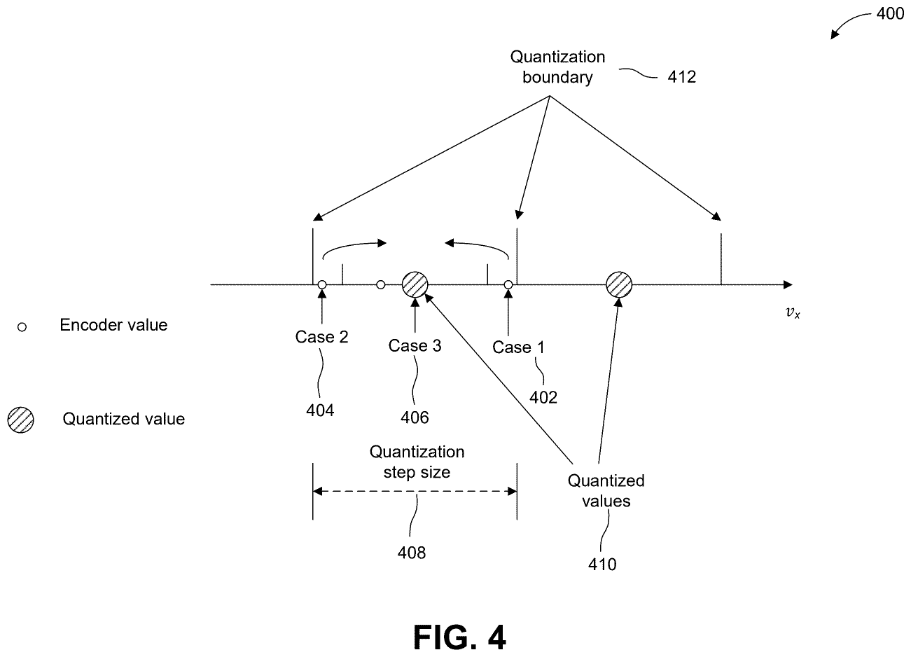

FIG. 4 is a schematic illustration showing a first example matching of raw values with quantized values according to some embodiments. The process 400 shows the cases 1, 2, and 3 (402, 404, 406) that correspond to cases 1, 2, and 3 of FIGS. 2 and 3. FIG. 4 shows several quantization boundaries 412 with quantized values 410 located at the halfway point between each respective set of quantization boundaries 412. Each quantization boundary 412 is separated by a quantization step size 408. Case 1 (402) is the scenario where the encoder value is shifted to the left of the quantization value 410. Case 2 (404) is the scenario where the encoder value is shifted to the right of the quantization value 410. Case 3 (406) is the scenario where the encoder value is set to the quantization value 410.

### Advanced Reproducible Coding

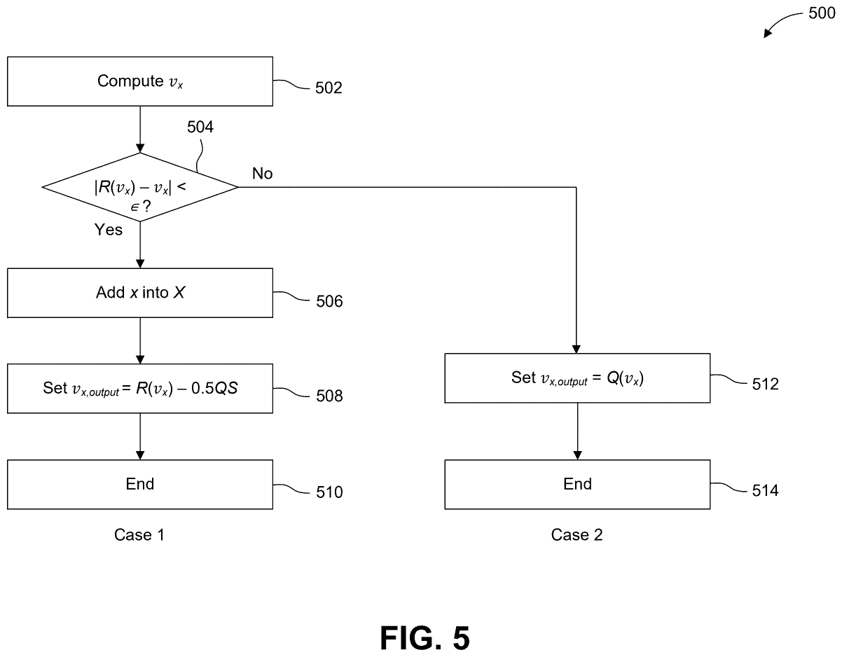

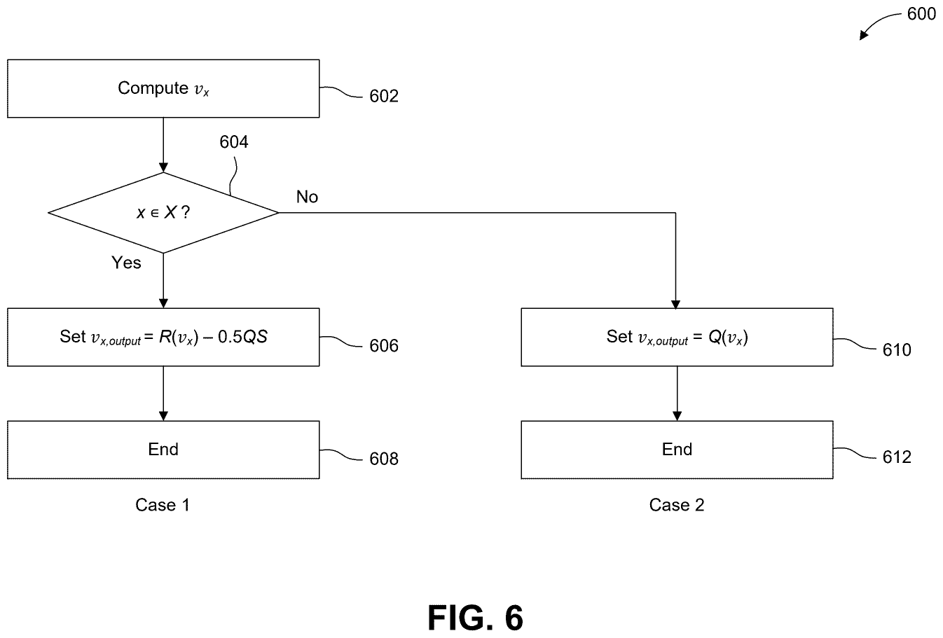

In the '370 application, some embodiments skip the coding of the flag fₓ into the bitstream. The modified encoding and decoding procedures are shown in FIG. 5 and FIG. 6.

FIG. 5 is a flowchart illustrating a second example reproducible encoder process according to some embodiments.

For the encoder process 500 of FIG. 5, the variable vₓ is computed 502. The absolute distance of the variable vₓ from its rounded position R(vₓ) is checked 504. If the error is larger than a certain threshold E, the variable is assumed to be in a “safe” range. The output is set 512 to its quantized value v_{x,output}=Q(vₓ) and case 2 ends 514.

Otherwise, the current point x is added 506 to set X (which is signaled to the decoder), and the variable vₓ is set 508 to v_{x,output}=R(vₓ)−0.5QS. In other words, the variable vₓ is shifted to the left of the rounded value by half of the quantization step. Then, case 1 ends 510.

The “left-preferred method” shown in FIG. 5 may appear less accurate because some values on the right side of the rounded value are quantized to a value not closest to the variable. However, the process 500 avoids signaling a flag fₓ.

FIG. 6 is a flowchart illustrating a second example reproducible decoder process according to some embodiments. For the decoder process 600 of FIG. 6, the variable vₓ is computed 602 and a determination 604 is made on whether a current point x belongs to the set X. If the current point x does not belong to the set X, the output is set 610 to its quantized value v_{x,output}=Q(vₓ) and case 2 ends 612. Otherwise, the output is set 606 to v_{x,output}=R(vₓ)−0.5QS and case 1 ends 608.

Similar to the “left-preferred method”, a “right-preferred” quantization may be performed. If the encoder detects that the current point is in the risky range, the output is set to be v_{x,output}=R(vₓ)+0.5 for the “right-preferred method”.

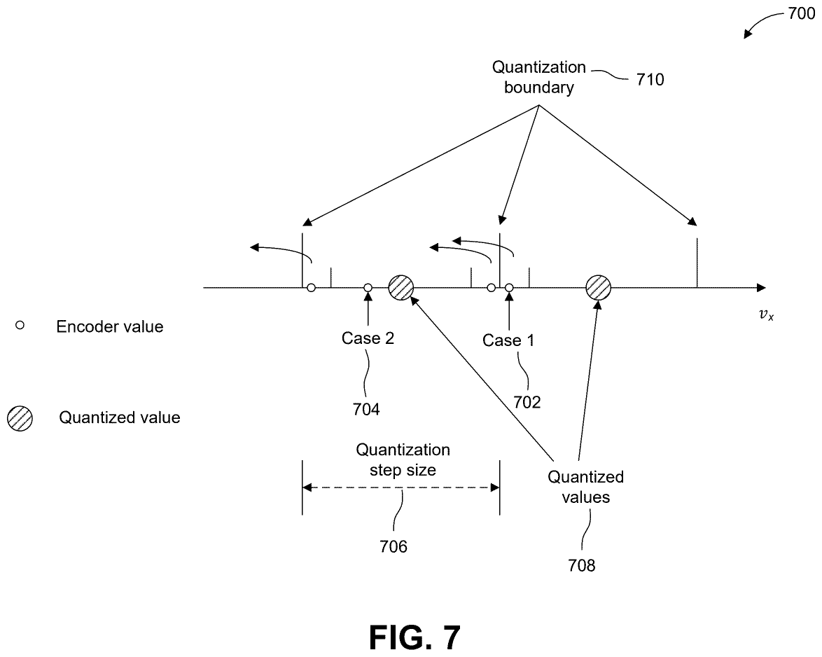

FIG. 7 is a schematic illustration showing a second example matching of raw values with quantized values according to some embodiments. The process 700 shows the cases 1 and 2 (702, 704) that correspond to cases 1 and 2 of FIGS. 5 and 6. FIG. 7 shows several quantization boundaries 710 with quantized values 708 located at the halfway point between each respective set of quantization boundaries 710. Each quantization boundary 710 is separated by a quantization step size 706. Case 1 (702) is the scenario where the encoder value is shifted to the left. Case 2 (704) is the scenario where the encoder value is set to the quantization value 708.

### Configuration 1

The '370 application codes the risky set X. The present application discusses how to code the risky set X efficiently. For some embodiments, the coding of the risky set X is equivalent to coding a binary mask for the values that are to be protected.

For illustration, suppose all the output values to be protected from a block are v=[v₁, v₂, . . . , vₙ]. For a value vᵢ that is risky and put into the risky set X, value vᵢ corresponds to a binary risky flag fᵢ=0. For a value vᵢ that is not risky, vᵢ corresponds to a binary risky flag fᵢ=1. The binary risky flags for all of the values constitute a binary protection mask, denoted as f=[f₁, f₂, . . . , fₙ]. Thus, the coding of the risky set X becomes the coding of the binary protection mask f. To code the binary protection mask f, arithmetic coding is performed based on the probability of the values in v being risky. Denote the risky probability by p, then the output protection bitstream is BS=AE(f,p), in which AE( ) denotes the arithmetic encoder.

In practice, the risky probability p may be estimated statistically or empirically. When estimated statistically, the risky probability (denoted as pₛ) is computed by Eq. 4:

$${p}_{s} = \frac{2 ϵ}{Q S} \qquad ( 4 )$$

The value ∈ is the maximum error, and QS is the quantization step size. When estimated empirically, the risky probability (denoted as pₑ) is computed by Eq. 5:

$${p}_{e} = \frac{{n}_{r}}{n} \qquad ( 5 )$$

in which nᵣ denotes the number of values that are labeled with risky, and n is the total number of values to be protected.

Using the empirical risky probability pₑ for arithmetic coding leads to a smaller bitstream BS compared to using the statistical risky probability pₛ. However, the empirical risky probability pₑ requires additionally coding the value pₑ itself so that the protection mask may be decoded on the decoder side. On the other hand, using the statistical probability pₛ for arithmetic coding does not require additional signaling of pₛ because the statistical probability pₛ may be computed by the decoder. Even so, the bitstream size BS may be larger compared to coding with the empirical risky probability pₑ.

In point cloud compression, the coding of an input point cloud is conducted from one scale to the next scale, from fine to coarse. In other words, the encoder (or decoder) traverses the octree representing the point cloud one level by one level, from the root level to the leaf level. To protect such multi-scale coding for reproducibility, the coding of each level (or scale) needs to be protected.

Suppose there are m octree levels in the point cloud. By applying a method of the '370 application, each of the octree level would be equipped with a binary protection mask to be coded. These m binary masks are denoted as f₁, f₂, . . . , fₘ, in which fᵢ is the protection mask of the i-th octree level. For illustration, the statistical risky probabilities of them are denoted by p_{s,1}, p_{s,2}, . . . , p_{s,m}, while the empirical risky probabilities of these masks are denoted by p_{e,1}, p_{e,2}, . . . , p_{e,m}.

For some embodiments, the binary masks f₁, f₂, . . . , fₘ may all be arithmetically coded with the statistical risky probabilities p_{s,1}, p_{s,2}, . . . , p_{s,m}. For some embodiments, the binary masks f₁, f₂, . . . , fₘ may all be coded with the empirical risky probabilities p_{e,1}, p_{e,2}, p_{e,m}.

However, in practice, the protection masks for the first few octree levels are usually very sparse (in other words, there are very few values that are labeled as risky). In this case, using the statistical risky probabilities to code the first few protection masks leads to very little bitrate savings for the coding of the protection bitstreams. On the contrary, using statistical risky probabilities bring additional overhead because the statistical risky probabilities themselves need to be coded for arithmetic decoding. As a result, coding the protection masks for the first few octree levels with the empirical risky probabilities may be more efficient.

Contrarily, when coding the protection masks for the last few octree levels, using the empirical risky probabilities may be more efficient. Usually, there are a lot more values that need to be protected for the last few octree levels. As a result, using the empirical risky probabilities to code the protection masks of the last few levels may be more efficient, even if the empirical risky probabilities for arithmetic decoding need to be coded.

Based on the above reasoning, the protection masks for the first k octree levels may be coded with the statistical risky probabilities p_{s,1}, p_{s,2}, . . . , p_{s,k}, and the protection masks of the remaining m-k levels may be coded with the empirical risky probabilities p_{s,k+1}, p_{s,k+2}, . . . , p_{s,m}.

In some embodiments, the number k may be a constant, e.g., k=7. In some embodiments, the number k is configurable and needs to be signaled to the decoder as a syntax element in the high level syntax.

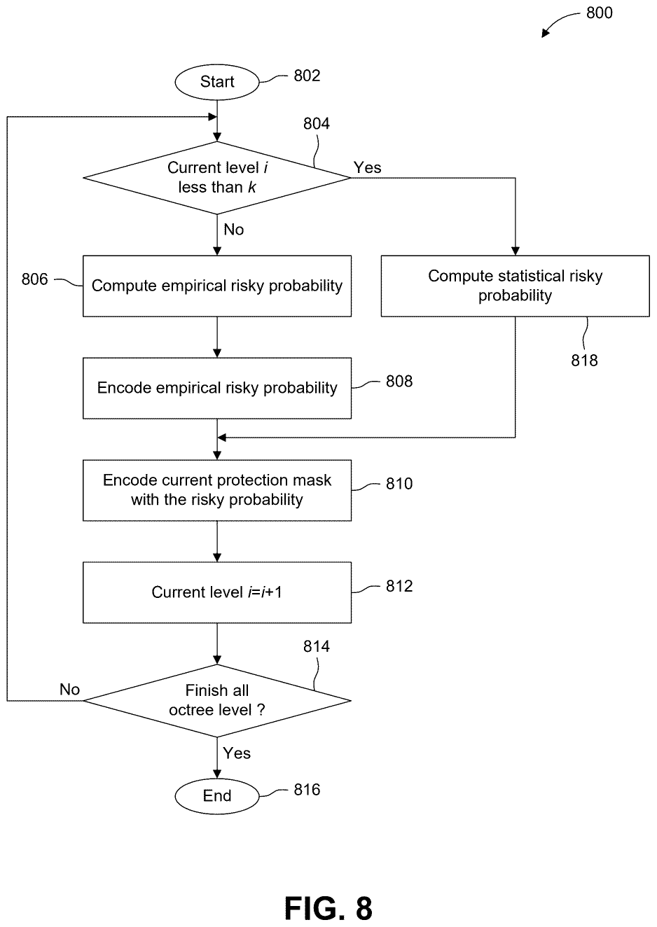

FIG. 8 is a flowchart illustrating an example encoder process according to some embodiments. The example encoder process 800 begins 802 a loop. A determination 804 is made of whether the current level i is less than k. If the determination 804 is “yes”, then the statistical risky probability is computed 818. If the determination 804 is “no”, then the empirical risky probability is computed 806. The empirical risky probability is encoded 808.

The “yes” and “no” paths merge back together, and the current protection mask is encoded 810 with the risky probability. The current level is updated 812 to be i=i+1. A determination 814 is made to determine if all of the octree levels are finished. If all of the octree levels are finished, then the example encoder process 800 ends 816. Otherwise, the encoder process 800 returns to the top of the loop.

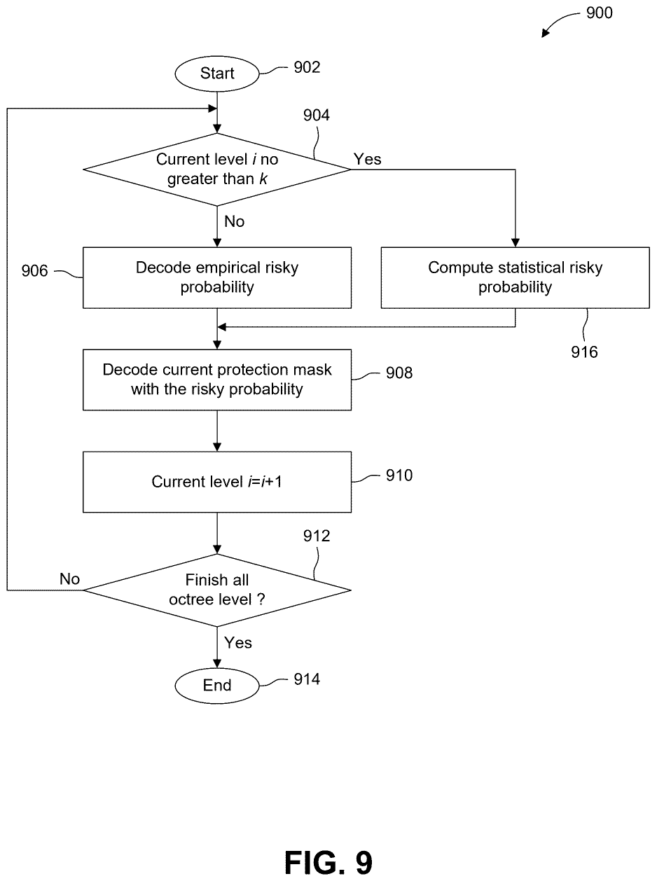

FIG. 9 is a flowchart illustrating an example decoder process according to some embodiments. The example decoder process 900 begins 902 a loop. A determination 904 is made of whether the current level i is greater than k. If the determination 904 is “yes”, then the statistical risky probability is computed 916. If the determination 904 is “no”, then the empirical risky probability is decoded 906.

The “yes” and “no” paths merge back together, and the current protection mask is decoded 908 with the risky probability. The current level is updated 910 to be i=i+1. A determination 912 is made to determine if all of the octree levels are finished. If all of the octree levels are finished, then the example decoder process 900 ends 914. Otherwise, the decoder process 900 returns to the top of the loop.

### Configuration 2 for Octree-Based Coding

In learning-based point cloud compression, the octree-based coding process compresses the first few levels (or all levels) of an input point clouds in a lossless manner. In the '379 application, the coding of one octree level is split into 8 coding iterations rather than coding in one iteration. By having this voxel-wise iterative coding approach in the '379 application, the total bitstream size to represent the occupancies for an octree level may be reduced.

The present application may be applied to the '379 application. In some embodiments, the coding of the protection masks of the first few k levels are performed based on statistical risky probabilities. The coding of the protection masks of the remaining levels is performed based on empirical risky probabilities. However, the computation of the empirical risky probabilities may be based on a different method than described earlier.

For illustration, this discussion will describe the coding of an octree level that is larger than k because the coding of the first k octree levels stays the same as what was described above. For some embodiments, the computation of the empirical risky probability for a current level is updated as shown in Eq. 6:

$${p}_{e}^{′} = \frac{{n}_{r , 1}}{{n}_{1}} \qquad ( 6 )$$

in which n₁ is the total number of voxels coded in the first coding iteration of the '379 application, and n_{r,1} is the number of risky values among them. With this modification, after the first coding iteration is finished, the updated empirical risky probability is used for coding for not only the first coding iteration but also the remaining coding iterations of the current octree level.

In some embodiments, for each of the coding iteration of the '379 application, the empirical risky probability is computed as shown in Eq. 7:

$${p}_{e , i}^{′} = \frac{{n}_{r , i}}{{n}_{i}} \qquad ( 7 )$$

in which nᵢ is the total number of voxels coded in the current coding iteration, and n_{r,i} is the number of risky values among them. Each of the eight (8) coding iterations is associated with its own empirical risky probability for the coding of its protection mask. In this case, the empirical risky probabilities are also coded for each of the coding iterations so that the decoder may arithmetically decode the eight (8) protection masks with the eight (8) individual empirical risky probabilities.

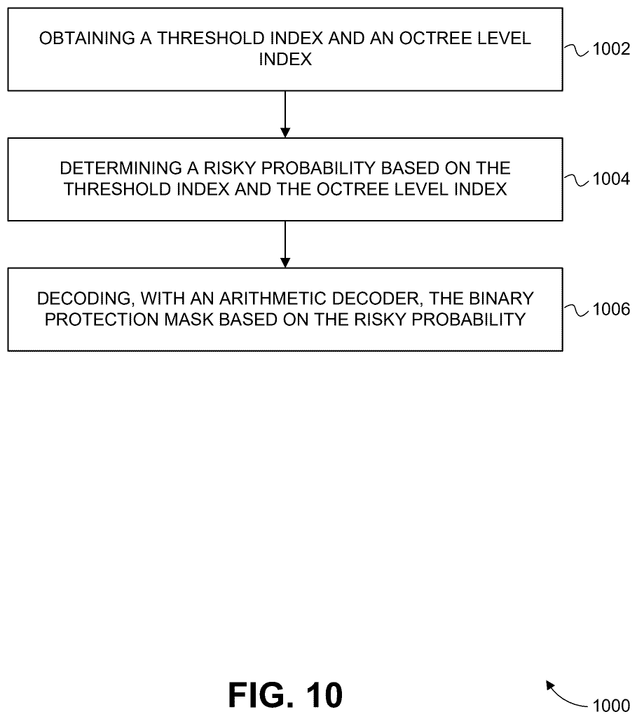

FIG. 10 is a flowchart illustrating an example decoding process according to some embodiments. For some embodiments, an example process 1000 may include obtaining 1002 a threshold index and an octree level index. For some embodiments, the example process 1000 may further include determining 1004 a risky probability based on the threshold index and the octree level index. For some embodiments, the example process 1000 may further include decoding 1006, with an arithmetic decoder, the binary protection mask based on the risky probability.

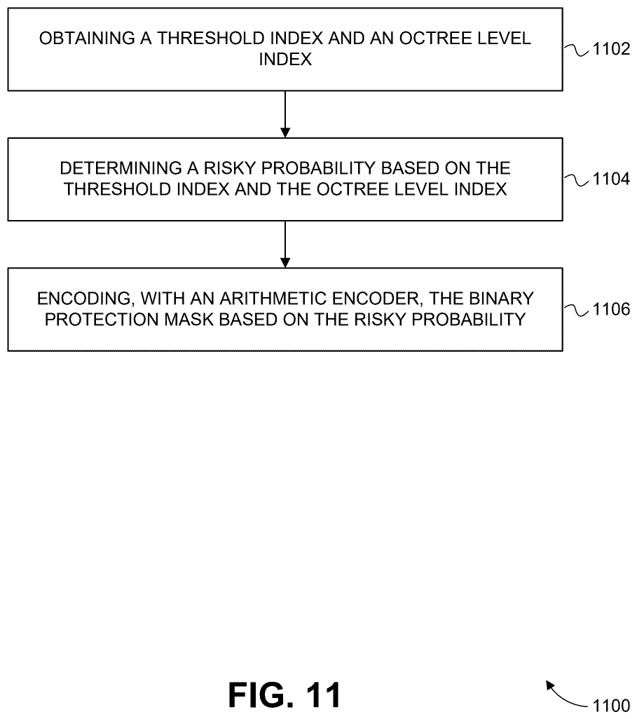

FIG. 11 is a flowchart illustrating an example encoding process according to some embodiments. For some embodiments, an example process 1100 may include obtaining 1102 a threshold index and an octree level index. For some embodiments, the example process 1100 may further include determining 1104 a risky probability based on the threshold index and the octree level index. For some embodiments, the example process 1100 may further include encoding 1106, with an arithmetic encoder, the binary protection mask based on the risky probability.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a threshold index and an octree level index; determining a risky probability based on the threshold index and the octree level index; and decoding, with an arithmetic decoder, the binary protection mask based on the risky probability.

Some embodiments of the first example method may further include determining that the octree level index is equal to the threshold index, wherein determining the risky probability includes determining the risky probability statistically.

Some embodiments of the first example method may further include determining that the octree level index is less than the threshold index, wherein determining the risky probability includes determining the risky probability statistically.

For some embodiments of the first example method, determining the risky probability statistically includes determining the risky probability based on a maximum error and a quantization step size.

Some embodiments of the first example method may further include determining that the octree level index is greater than the threshold index, wherein determining the risky probability includes decoding the risky probability.

Some embodiments of the first example method may further include: obtaining a bitstream; decoding the bitstream; and parsing the risky probability from the decoded bitstream.

Some embodiments of the first example method may further include repeating a decoding loop for a second octree-level, wherein the decoding loop includes: obtaining a second threshold index and a second octree level index; determining a second risky probability based on the second threshold index and the second octree level index; and decoding, with the arithmetic decoder, a second binary protection mask based on the second risky probability.

For some embodiments of the first example method, the threshold index is a single digit constant.

A first example apparatus in accordance with some embodiments may include: a processor; and a memory storing instructions operative, when executed by the processor, to cause the apparatus to: obtain a threshold index and an octree level index; determine a risky probability based on the threshold index and the octree level index; and decode, with an arithmetic decoder, the binary protection mask based on the risky probability.

A second example method in accordance with some embodiments may include: obtaining a threshold index and an octree level index; determining a risky probability based on the threshold index and the octree level index; and encoding, with an arithmetic encoder, the binary protection mask based on the risky probability.

Some embodiments of the second example method may further include determining that the octree level index is equal to the threshold index, wherein determining the risky probability includes determining the risky probability statistically.

Some embodiments of the second example method may further include determining that the octree level index is less than the threshold index, wherein determining the risky probability includes determining the risky probability statistically.

For some embodiments of the second example method, determining the risky probability statistically includes determining the risky probability based on a maximum error and a quantization step size.

Some embodiments of the second example method may further include determining that the octree level index is greater than the threshold index, wherein determining the risky probability includes determining the risky probability empirically.

For some embodiments of the second example method, determining the risky probability empirically includes determining the risky probability based on total number of voxels coded and number of risky voxels within the total number of voxels coded.

For some embodiments of the second example method, determining the risky probability empirically is determined specifically for the octree level corresponding to the octree level index.

Some embodiments of the second example method may further include encoding the risky probability into a bitstream.

Some embodiments of the second example method may further include repeating an encoding loop for a second octree-level, wherein the encoding loop includes: obtaining a second threshold index and a second octree level index; determining a second risky probability based on the second threshold index and the second octree level index; and encoding, with the arithmetic encoder, a second binary protection mask based on the second risky probability.

For some embodiments of the second example method, obtaining the threshold index includes determining the threshold index.

For some embodiments of the second example method, determining the threshold index includes setting the threshold index based on density of the binary protection mask.

One or more embodiments provide a computer program including instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods include one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a“first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of decoding a binary protection mask for an octree-level, comprising:
obtaining a threshold index and an octree level index;
determining a risky probability based on the threshold index and the octree level index; and
decoding, with an arithmetic decoder, the binary protection mask based on the risky probability.

2. The method of claim 1, further comprising:
determining that the octree level index is equal to the threshold index,
wherein determining the risky probability comprises determining the risky probability statistically.

3. The method of claim 1, further comprising:
determining that the octree level index is less than the threshold index,
wherein determining the risky probability comprises determining the risky probability statistically.

4. The method of claim 3, wherein determining the risky probability statistically comprises determining the risky probability based on a maximum error and a quantization step size.

5. The method of claim 1, further comprising:
determining that the octree level index is greater than the threshold index,
wherein determining the risky probability comprises decoding the risky probability.

6. The method of claim 1, further comprising:
obtaining a bitstream;
decoding the bitstream; and
parsing the risky probability from the decoded bitstream.

7. The method of claim 1, further comprising:
repeating a decoding loop for a second octree-level,
wherein the decoding loop comprises:
obtaining a second threshold index and a second octree level index;
determining a second risky probability based on the second threshold index and the second octree level index; and
decoding, with the arithmetic decoder, a second binary protection mask based on the second risky probability.

8. The method of claim 1, wherein the threshold index is a single digit constant.

9. An apparatus comprising:
a processor; and
a memory storing instructions operative, when executed by the processor, to cause the apparatus to:
obtain a threshold index and an octree level index;
determine a risky probability based on the threshold index and the octree level index; and
decode, with an arithmetic decoder, the binary protection mask based on the risky probability.

10. A method of encoding a binary protection mask for an octree-level, comprising:
obtaining a threshold index and an octree level index;
determining a risky probability based on the threshold index and the octree level index; and
encoding, with an arithmetic encoder, the binary protection mask based on the risky probability.

11. The method of claim 10, further comprising:
determining that the octree level index is equal to the threshold index,
wherein determining the risky probability comprises determining the risky probability statistically.

12. The method of claim 10, further comprising:
determining that the octree level index is less than the threshold index,
wherein determining the risky probability comprises determining the risky probability statistically.

13. The method of claim 12, wherein determining the risky probability statistically comprises determining the risky probability based on a maximum error and a quantization step size.

14. The method of claim 10, further comprising:
determining that the octree level index is greater than the threshold index,
wherein determining the risky probability comprises determining the risky probability empirically.

15. The method of claim 14, wherein determining the risky probability empirically comprises determining the risky probability based on total number of voxels coded and number of risky voxels within the total number of voxels coded.

16. The method of claim 15, wherein determining the risky probability empirically is determined specifically for the octree level corresponding to the octree level index.

17. The method of claim 10, further comprising encoding the risky probability into a bitstream.

18. The method of claim 10, further comprising:
repeating an encoding loop for a second octree-level,
wherein the encoding loop comprises:
obtaining a second threshold index and a second octree level index;
determining a second risky probability based on the second threshold index and the second octree level index; and
encoding, with the arithmetic encoder, a second binary protection mask based on the second risky probability.

19. The method of claim 10, wherein obtaining the threshold index comprises determining the threshold index.

20. The method of claim 19, wherein determining the threshold index comprises setting the threshold index based on density of the binary protection mask.
